(19) United States
(12) Patent Application Publication
(10) Pub. No.: US 2026/0188031 A1
(43) Pub. Date: Jul. 2, 2026

(54) OBJECT DETECTION BASED ON SCENE UNDERSTANDING AND TEMPORAL INFORMATION

(71) Applicant: Intel Corporation, Santa Clara, CA (US)

(72) Inventors: Ido Nissenboim, Zichron Yaakov (IL); Alexander Itskovich, Kiryat Bialik (IL); Anatoly Litvinov, Binyamina (IL); Dmitry Rudoy, Haifa (IL)

(73) Assignee: Intel Corporation, Santa Clara, CA (US)

(21) Appl. No.: 19/544,545

(22) Filed: Feb. 19, 2026

(51) Int. Cl. G06V 20/70; G06V 20/40

(52) U.S. Cl. CPC G06V 20/70; G06V 20/41

(57) ABSTRACT

Systems and methods are provided for object detection that identify objects based on semantic understanding of a scene and its temporal evolution. An image frame is processed by a semantic segmentation model to generate a segmentation map in which pixels are assigned to semantic classes, and the segmentation can incorporate temporal information to maintain consistency of semantic labeling across consecutive frames. Scene structure analysis is performed to infer object hypotheses from spatial and semantic relationships among the detected classes. In various examples, combinations of semantically related regions are interpreted as an object and/or objects can be inferred from combinations of semantic classes and contextual dependencies. Object detections are generated based on semantically consistent regions that satisfy predefined or learned relationships, and confidence can be derived from semantic coherence rather than local visual similarity. In multi-object scenarios, additional logic may be applied to separate detections, such as connected-components analysis.

### TECHNICAL FIELD

This disclosure relates generally to image processing, and in particular to object detection based on scene understanding and temporal information.

### BACKGROUND

Current object detection methods rely primarily on visual or geometric appearance features extracted from single images, which makes such methods fragile under occlusion, lighting variation, pose changes, and domain shifts. Additionally, detection performance degrades or fails when defining object features are missing or distorted. Conventional convolutional-and transformer-based detectors (including, for example, Faster R-CNN, YOLO, and DETR) operate by learning and matching appearance patterns rather than reasoning over the semantic meaning of a scene. As a result, the detectors remain sensitive to partial visibility and other real-world conditions in which characteristic visual cues are not reliably observable.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 is a block diagram of an object detection system, in accordance with various embodiments.

FIG. 2 is a block diagram of a spatiotemporal scene understanding module, in accordance with various embodiments.

FIG. 3 is a block diagram of a scene structure analysis module, in accordance with various embodiments.

FIGS. 4A and 4B illustrate an example of how the semantic-and temporal-based object detection framework operates on a representative scene, in accordance with various embodiments.

FIGS. 5A and 5B are illustrations of scene understanding-based detection, in accordance with various embodiments.

FIG. 6 is a flowchart showing a method for object detection, in accordance with various embodiments.

FIG. 7 is a block diagram of an example Deep Neural Network (DNN) system, in accordance with various embodiments.

FIG. 8 is a block diagram of an example computing device, in accordance with various embodiments.

### DETAILED DESCRIPTION

### Overview

Object detection techniques are provided that identify one or more objects based on semantic understanding of a scene and its temporal evolution, rather than relying solely on localized appearance cues. In some examples, the disclosed techniques analyze the meaning and relationships of regions within an image sequence (e.g., semantically labeled regions) and leverage temporal consistency across frames to generate object detections that remain robust under occlusion, lighting variation, pose changes, and domain shifts. The systems and methods provided herein can detect objects in scenarios in which defining visual features of an object are missing or distorted.

Conventional object detection systems, such as convolutional-and transformer-based approaches, generally operate by extracting and matching appearance patterns from individual images. As a result, these detectors can fail when an object is partially visible, stylized, shadowed, masked, or otherwise presented such that expected visual landmarks or characteristic features are degraded, and the detection tends to degrade or fail when the required features are absent. Although some systems have explored temporal or contextual cues (e.g., Context R-CNN and Video DETR), such approaches remain largely limited to appearance-based correlations across frames rather than semantic reasoning over the scene structure and the relationships among semantically meaningful regions. Consequently, these approaches remain sensitive to lighting, occlusion, pose variation, and domain shift, and rely on the presence of certain features in challenging conditions. For example, face detectors often fail when the face is masked, rotated, partially covered, or heavily shadowed, since the defining landmarks are missing or distorted.

To address these limitations, systems and methods are provided herein to implement a semantic-and temporal-based object detection framework in which an input image frame (or sequence of frames) is processed by a semantic segmentation model and undergoes scene structure analysis, and object detections are generated. The object detection framework can include a semantic segmentation model to produce a segmentation map. The segmentation map assigns pixels to predefined semantic classes and/or background. In some implementations, the segmentation incorporates temporal information to maintain consistency of semantic labeling across consecutive frames, thereby providing a semantically coherent representation of the scene that can be reused for detection without a separate tracking stage.

According to various implementations, following semantic segmentation, the system performs scene structure analysis to infer object hypotheses from spatial and semantic relationships among the detected classes. In some examples, scene structure analysis uses deterministic, rule-based composition in which combinations of semantically related regions are interpreted as an object. In some examples, scene structure analysis uses pre-defined logic and/or pre-defined rules to determine which combinations of semantically related regions are interpreted as an object. For example, a face may be defined as a union of specified facial-region classes. Optionally, adjacency and/or coverage thresholds can be used. In some examples, scene structure analysis may include learned or probabilistic reasoning layers that infer object presence from combinations of semantic classes and contextual dependencies, allowing the semantic-driven pipeline to evolve from constant rules to adaptive inference mechanisms while preserving the overall architecture.

According to various implementations, in the object detection output stage, the system generates detections based on the semantically consistent regions that satisfy the predefined or learned relationships. For multi-object scenarios, additional logic may be applied to separate detections, such as connected-components analysis. Similarly, in multi-object scenarios, confidence may be derived from semantic coherence rather than local visual similarity. Thus, object detections can be stable across changes in appearance and partial visibility. In some examples, the disclosed approach provides pixel-accurate detection and pixel-wise confidence. In contrast, other systems provide only a bounding region with a single confidence score.

In various implementations, the systems and methods provided herein reuse outputs of an existing scene understanding (e.g., semantic segmentation) algorithm already present in the system. Thus, the techniques allow for additional object detection functionality with reduced latency and power relative to systems that use a separate dedicated detector.

For purposes of explanation, specific numbers, materials, and configurations are set forth in order to provide a thorough understanding of the illustrative implementations. However, it will be apparent to one skilled in the art that the present disclosure may be practiced without the specific details and/or that the present disclosure may be practiced with only some of the described aspects. In other instances, well-known features are omitted or simplified in order not to obscure the illustrative implementations.

Further, references are made to the accompanying drawings that form a part hereof, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A and/or B” or the phrase “A or B” means (A), (B), or (A and B). For the purposes of the present disclosure, the phrase “A, B, and/or C” or the phrase “A, B, or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value based on the input operand of a particular value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value based on the input operand of a particular value as described herein or as known in the art.

In addition, the terms “comprise,” “comprising,” “include,” “including,” “have,” “having” or any other variation thereof, are intended to cover a non-exclusive inclusion. For example, a method, process, device, or system that comprises a list of elements is not necessarily limited to only those elements but may include other elements not expressly listed or inherent to such method, process, device, or systems. Also, the term “or” refers to an inclusive “or” and not to an exclusive “or.”

The systems, methods, and devices of this disclosure each have several innovative aspects, no single one of which is solely responsible for all desirable attributes disclosed herein. Details of one or more implementations of the subject matter described in this specification are set forth in the description below and the accompanying drawings.

### Example Object Detection System

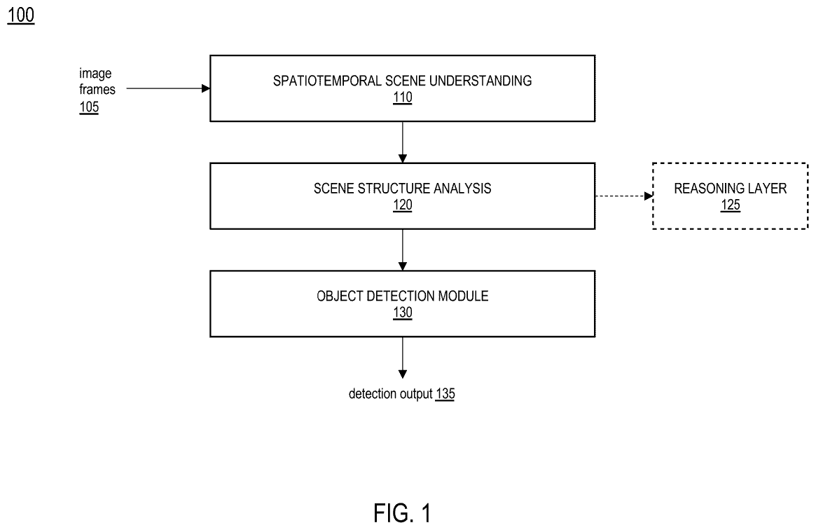

FIG. 1 is a block diagram of an object detection system 100, in accordance with various embodiments. In particular, the object detection system 100 performs semantic-and temporal-based object detection using scene understanding and temporal information. The object detection system 100 receives image frames 105 (e.g., a sequence of image frames) as input, provides the image frames 105 to a spatiotemporal scene understanding module 110, provides an output of the spatiotemporal scene understanding module 110 to a scene structure analysis module 120, and provides information to an object detection module 130 that generates a detection output 135. In some examples, the object detection system 100 includes a reasoning layer 125 coupled to the scene structure analysis module 120.

In some implementations, the image frames 105 include a sequence of video frames, and the spatiotemporal scene understanding module 110 generates, for a selected frame of the sequence, a segmentation map that assigns pixels to semantic classes based in part on feedback from at least one previous frame of the sequence. In some examples, the spatiotemporal scene understanding module 110 can include a temporal semantic segmentation network that uses a backbone (e.g., MobileNet V3 Large) and a temporal decoding unit (e.g., a convolutional GRU) that enables feedback. In various examples, the temporal decoding unit can enable feedback at different resolutions from previous frames. In some examples, the segmentation map for the selected frame is generated based in part on a respective segmentation map (or related state) for a previous frame.

The spatiotemporal scene understanding module 110 outputs a segmentation representation of the scene in which each pixel is assigned to one of a plurality of predefined semantic classes (and/or background). In some examples, each pixel is further associated with a confidence for the assigned class. Example classes for face-related embodiments include facial skin, facial hair, hair, clothing, and non-facial skin, although other object domains may use other class sets. The temporal feedback supported by the spatiotemporal scene understanding module 110 can improve stability when an object becomes partially occluded, such as when a face is briefly covered, by leveraging information from previous frames. In some implementations, the spatiotemporal scene understanding module 110 may be implemented using different topologies while preserving the same functional role. For instance, the spatiotemporal scene understanding module 110 may be implemented using a YOLO-based topology, provided that the output is a temporally informed segmentation map usable for downstream scene reasoning.

The scene structure analysis module 120 operates on the segmentation map produced by the spatiotemporal scene understanding module 110. In particular, the scene structure analysis module 120 determines spatial relationships and semantic coherence between semantic classes in the segmentation map. In various examples, the scene structure analysis module 120 identifies semantically related regions (e.g., regions classified as facial skin and facial hair) and evaluates adjacency, coverage, and other spatial constraints to infer object hypotheses, such as defining a face as a union of specified facial-region classes. In multi-object scenarios, the scene structure analysis module 120 can separate candidate regions using connected-components style logic on the semantically consistent regions. In some examples, determining semantic coherence includes determining a coherence score that quantifies to what extent the semantic classes, their confidences, and their spatial arrangement jointly support the presence of an object in the selected frame.

The reasoning layer 125 is an optional component coupled to the scene structure analysis module 120. In various examples, a reasoning layer 125 may be used to augment or replace rule-based composition with learned or otherwise adaptive inference. For instance, the reasoning layer 125 may include a learned model (e.g., a small neural network) or a classical classifier (e.g., a support vector machine). The reasoning layer 125 learns to identify object presence from combinations of semantic classes, per-pixel class confidences, contextual dependencies, and the determined spatial relationships. In various examples, the reasoning layer 125 allows the scene structure analysis module 120 to evolve from fixed rules to a learnable or probabilistic reasoning process while preserving the overall pipeline.

The object detection module 130 identifies at least one object in the selected frame based on the spatial relationships and the semantic coherence determined by the scene structure analysis module 120 (and, in some examples, the reasoning layer 125). The object detection module 130 generates the detection output 135 as an object detection output defining the at least one object and a corresponding confidence score based on the semantic coherence, and outputs the detection output 135 for downstream consumption. In various examples, the detection output 135 can include a bounding region, a pixel-accurate mask, or another suitable representation. In some examples, the confidence score can be derived from semantic coherence rather than local appearance similarity. Thus, the object detection module 130 provides increased robustness under occlusion, lighting variation, pose changes, and cross-domain conditions.

In some implementations, an imaging system already present on a device can include a segmentation capability corresponding to the spatiotemporal scene understanding module 110. In some examples, the scene structure analysis module 120 and the object detection module 130 reuse the segmentation results to provide object detection at almost no cost, reducing added latency and power relative to running a separate appearance-based object detector. Reuse of the segmentation capabilities already present can also improve responsiveness in control loops (e.g., internal camera algorithms), because a legacy face detector that relied on landmarks and ran in post-processing after capture could introduce delay (e.g., running once every few frames and producing detections only after a few frames). In contrast, the object detection system 100 can provide more immediate, temporally stable detections that can be used for tasks such as maintaining tracking, assisting auto-exposure, or other camera settings, even when only a small part of a face is visible.

In some examples, the object detection system 100 can be particularly advantageous in cases where conventional detectors fail due to missing or distorted visual landmarks, including partial occlusions (e.g., a hand or object covering the mouth or face), head rotation, challenging illumination (including red lighting), multiple persons, fast movements, and variations such as different skin tones. In such cases, the object detection system 100 can maintain object identification by relying on semantically coherent scene understanding (e.g., consistent detection of facial skin and facial hair classes over time) rather than brittle appearance features.

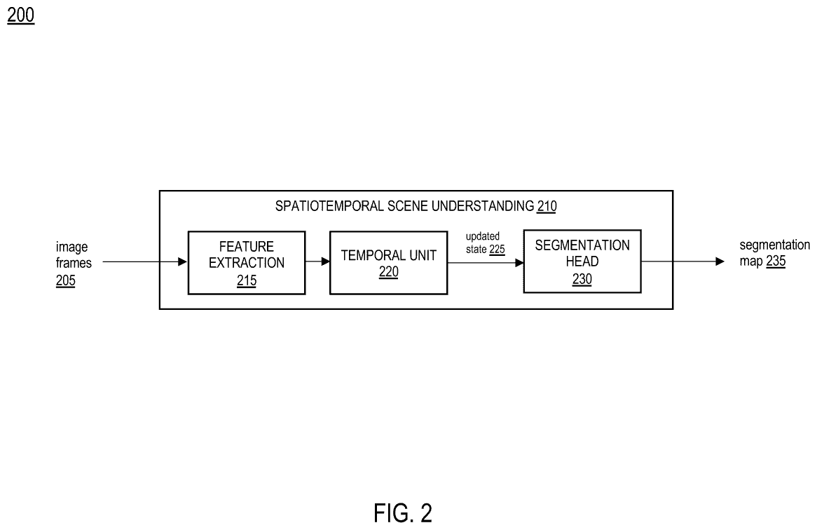

FIG. 2 is a block diagram 200 of a spatiotemporal scene understanding module 210, in accordance with various embodiments. The spatiotemporal scene understanding module 210 receives a sequence of image frames 205 and processes each image frame to generate a segmentation map 235 for the selected frame of the sequence. In particular, the spatiotemporal scene understanding module 210 is configured to generate, for the selected frame, a segmentation map 235 that assigns pixels to semantic classes. The segmentation map 235 is generated based in part on feedback from at least one previous frame of the sequence of image frames. In some examples, using feedback from a previous frame helps to maintain semantic consistency of segmentation maps across consecutive frames.

According to some examples, within the spatiotemporal scene understanding module 210, a feature extraction module 215 receives the image frames 205 and produces feature representations for the selected frame. The feature extraction module 215 may be implemented using a lightweight backbone network to extract spatial features that are predictive of semantic classes. The extracted features are provided to a temporal unit 220 that incorporates temporal information to support generation of the segmentation map 235 for the selected frame based in part on feedback from at least one previous frame.

The temporal unit 220 uses feedback across frames to produce an updated state 225 that reflects temporal context derived from the sequence of image frames. In some implementations, the feedback used by the temporal unit 220 includes a respective segmentation map for the at least one previous frame (for example, a respective segmentation map previously generated for a prior image), thereby enabling the spatiotemporal scene understanding module 210 to “remember” prior semantic structure when the selected frame includes occlusion or other degradations.

In some examples, the temporal unit 220 can include a temporal decoding mechanism (such as a convolutional GRU-based unit) that provides feedback at different resolutions from previous frames. In some examples, the temporal unit 220 receives a current feature map and a prior hidden state (or other feedback derived from at least one previous frame), and determines gating signals and an updated hidden state using convolutional kernels applied to the current feature map and the prior hidden state. The updated state 225 output from the temporal unit 220 can include the updated hidden state as temporal feedback for generating the segmentation map for the selected frame.

A segmentation head 230 receives the updated state 225 (and, in some examples, feature information generated by the feature extraction module 215) and generates the segmentation map 235 for the selected frame. The segmentation map 235 assigns pixels to semantic classes. In some examples, the segmentation map 235 provides a per-pixel confidence associated with the assigned semantic class. The segmentation map 235 output by the segmentation head 230 may be used by downstream logic (e.g., a scene structure analysis module) to determine spatial relationships between the semantic classes and to determine semantic coherence between the semantic classes.

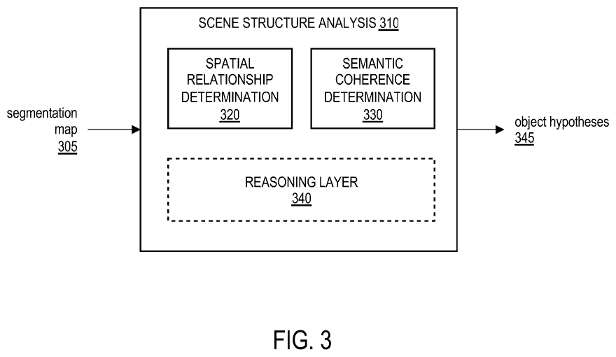

FIG. 3 is a block diagram 300 of a scene structure analysis module 310, in accordance with various embodiments. The scene structure analysis module 310 receives as input a segmentation map 305 and generates object hypotheses 345 using both spatial and semantic analysis. As shown in FIG. 3, the scene structure analysis module 310 includes a spatial relationship determination module 320, a semantic coherence determination module 330, and a reasoning layer 340. The segmentation map 305 can correspond to a selected frame of a sequence of image frames.

In various implementations, the spatial relationship determination module 320 determines spatial relationships between the semantic classes represented in the segmentation map 305. For example, the spatial relationship determination module 320 may apply deterministic, rule-based composition that relies on predefined adjacent and coverage thresholds to form relationships among semantically related regions, such as adjacency, overlap, coverage, or relative arrangement of regions corresponding to different semantic classes. In some examples, the spatial relationship determination module 320 may apply pre-defined logic and/or pre-defined rules to form relationships among semantically related regions. In one example, spatial analysis of a detected face may include analysis of the union or arrangement of regions corresponding to facial skin and facial hair (and potentially other scene components) as part of forming an object-related hypothesis from the segmentation map 305.

The semantic coherence determination module 330 determines semantic coherence between the semantic classes in the segmentation map 305. In some examples, the semantic coherence determination module 330 determines whether combinations of semantic classes and the spatial relationships between/among semantic classes are semantically consistent with an object hypothesis. In some examples, determining semantic coherence includes determining a coherence score that quantifies semantic compatibility among the semantic classes and/or among regions corresponding to those classes. In some implementations, the semantic coherence score can be used downstream to support robust object identification in scenarios where appearance-based landmarks or features are missing or unreliable. In some examples, confidence for a resulting detection may be derived from semantic coherence rather than local visual similarity. Using semantic coherence can help support stable detections under occlusion, lighting variation, or appearance changes, since the inference is grounded in scene semantics and relationships.

In some implementations, the scene structure analysis module 310 includes an optional reasoning layer 340. The reasoning layer 340 receives as input the output of the spatial relationship determination module 320 and the output of the semantic coherence determination module 330. In some implementations, the reasoning layer 340 also operates on the segmentation map 305, including on semantic-class structure derived from the segmentation map 305. The reasoning layer 340 optionally incorporates temporal feedback information implicit in the segmentation map generation for a selected frame.

The reasoning layer 340 identifies at least one object in the selected frame based on the spatial relationships and the semantic coherence. In various examples, the reasoning layer 340 may implement a rule-based or compositional inference that combines semantically related regions to generate object hypotheses 345. For instance, in some implementations, the reasoning layer 340 can receive as input various regions of facial skin and facial hair, and the reasoning layer 340 can bound the regions of facial skin and the regions of facial hair to produce a face hypothesis. In some examples, the reasoning layer 340 can use connected-components analysis to separate multiple objects. In various examples, the reasoning layer 340 can include learned or probabilistic reasoning layers that infer object presence from combinations of semantic classes. The combinations of semantic classes can include learning non-linear relationships, relative geometry, and/or contextual dependencies between regions (e.g., hair adjacent to skin forming a face, or wheels aligned under a body forming a vehicle).

The reasoning layer 340 outputs object hypotheses 345 that represent candidate objects identified in the selected frame. In some implementations, the reasoning layer 340 can support generation of an object detection output defining one or more objects and corresponding confidence scores based on the semantic coherence. In some implementations, the reasoning layer 340 includes a trainable model, such as a small network, rather than operating on fixed rules. In some implementations, the reasoning layer 340 utilizes a simple machine learning approach, such as a support vector machine (SVM) or other algorithms. The reasoning layer 340 may be implemented using various models, depending on the complexity of the relationship being inferred.

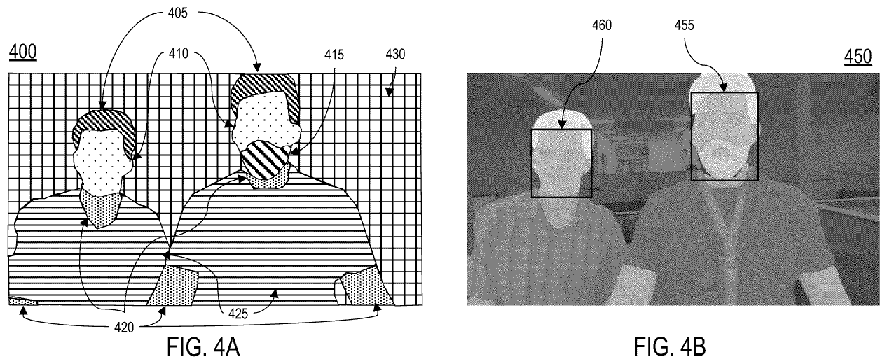

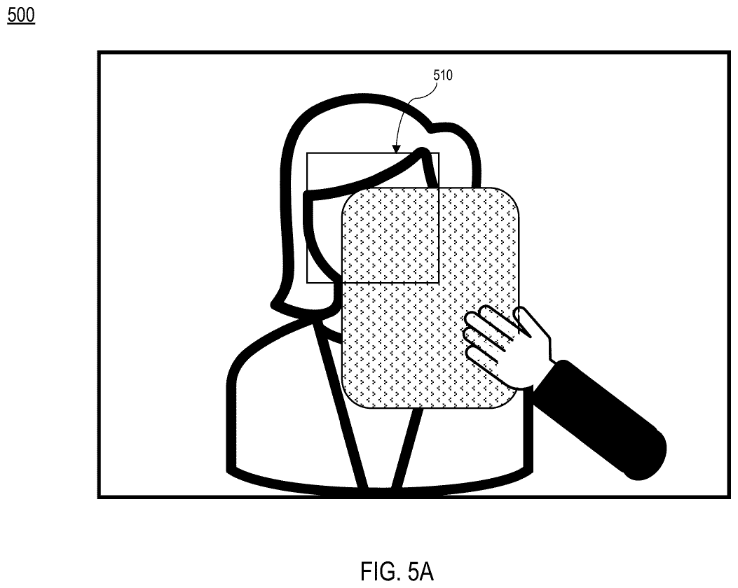

FIGS. 4A and 4B illustrate an example of how the semantic-and temporal-based object detection framework may operate on a representative scene in accordance with various embodiments. FIG. 4A is an illustration 400 of semantic scene analysis, in accordance with various embodiments. In particular, FIG. 4A depicts a semantic segmentation map of a representative image (e.g., a video frame) of a scene that includes multiple subjects and surrounding scene content. The representative image can be processed by a spatiotemporal scene understanding module that generates the semantic segmentation map for the frame. As shown in FIG. 4A, each region of the input image is identified as belonging to a semantic class, as illustrated by the patterns in the various regions and reference numbers identifying each region 405, 410, 415, 420, 425, and 430. Specifically, facial skin region 405 points to regions predicted to be facial skin, facial hair region 410 points to regions predicted to be facial hair, hair region 415 points to regions predicted to be hair, clothes region 420 points to regions predicted to be clothes, non-facial skin region 425 points to regions predicted to be non-facial skin, and background region 430 points to regions predicted to be background. In some examples, a per-pixel confidence for the assigned class is included in the segmentation map. In various examples, the semantic segmentation map illustrated in FIG. 4A may be generated in a temporally informed manner, in which information from one or more previous frames of the sequence is fed back to improve stability of semantic labeling for the current frame.

FIG. 4B is an illustration 450 of a semantic scene understanding result and object detection output corresponding to FIG. 4A, in accordance with various embodiments. In particular, FIG. 4B also depicts an example object detection output in which objects 455 and 460 correspond to respective object hypotheses derived from semantically consistent regions identified in the segmentation output. For example, semantically related regions (for example, facial-skin regions and facial-hair regions) can be joined together to define a face. A bounding region can be generated around the semantically related regions to identify an object (e.g., bounding region 455 identifying a first face, and bounding region 460 identifying a second face). In some examples, multiple objects are present, and separation logic such as connected-components analysis may be applied to separate distinct object regions prior to outputting multiple detections. Accordingly, in FIG. 4B, the bounding regions 455 and 460 may each correspond to a respective separated region (or union of regions) satisfying predetermined or learned semantic relationships, with an associated confidence derived from semantic coherence.

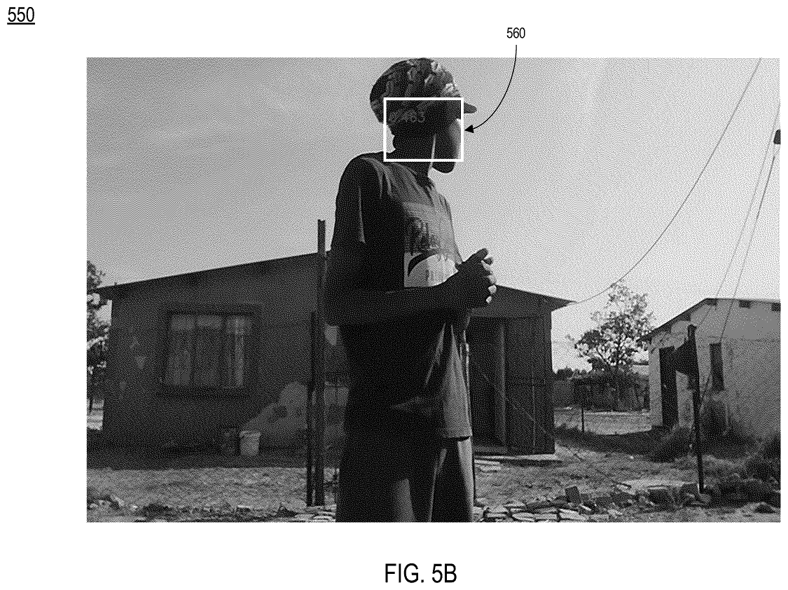

FIGS. 5A and 5B are illustrations 500, 550 of scene understanding-based detection, in accordance with various embodiments. As shown in FIG. 5A, the person's face 510 is covered with a paper, tablet, or other object, such that facial features such as eyes, nose, and mouth are not visible. As shown in FIG. 5B, the person's face 560 is turned away from the camera, also obscuring facial features. Conventional object detection techniques that rely on localized visual features (e.g., landmarks such as the eyes, nose, and mouth) can become fragile under occlusion and related variation and fail to detect the area corresponding to the person's face. In contrast, the systems and methods provided herein use a deep understanding of the scene itself to support detection even when the object's defining visual features are absent or obscured. The semantic analysis techniques provided can be utilized to identify the face (e.g., 510, 560) based on the hair above the face, the neck (skin area) below the face, and the shirt, and understand that the skin of the face that is exposed is facial skin and a part of a face. Additionally, the object detection system provided herein can incorporate temporal information to maintain consistency of semantic labeling across consecutive frames, and the feedback between frames can enable the system to remember where an object (e.g., a face) was in previous frames even if it becomes covered in a current frame.

### Example Method for Object Detection

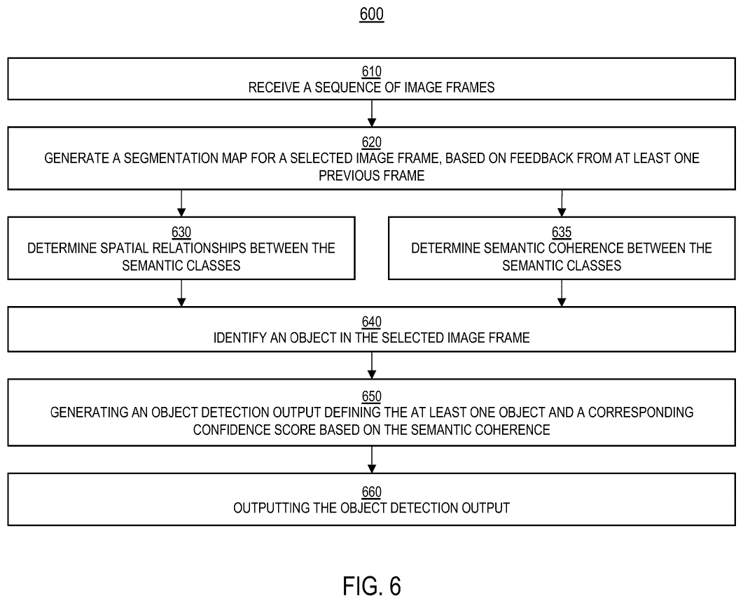

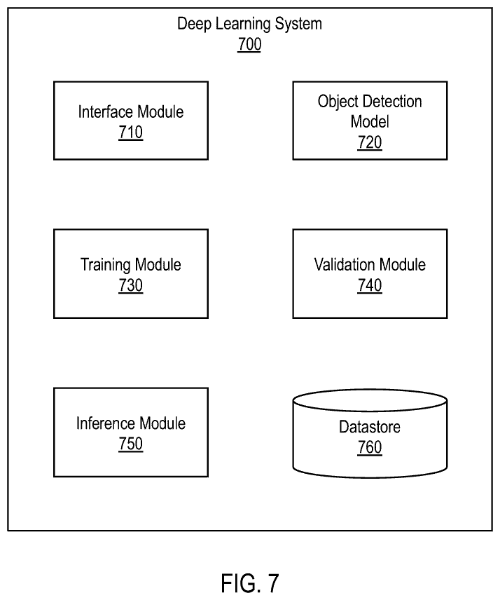

FIG. 6 is a flowchart showing a method 600 for object detection, in accordance with various embodiments. In particular, FIG. 6 illustrates a method 600 for performing semantic-and temporal-based object detection using scene understanding information derived from a sequence of image frames. The method 600 may be performed by the system 100 of FIG. 1, and/or by the deep learning system 700 in FIG. 7. Although the method 600 is described with reference to the flowchart illustrated in FIG. 6, other methods for object detection may alternatively be used. For example, the order of execution of the steps in FIG. 6 may be changed. As another example, some of the steps may be changed, eliminated, or combined.

At 610, a sequence of image frames is received for analysis. The image frames may be processed as a video sequence in which temporal information can be leveraged across consecutive frames, rather than treating each frame as an independent still image. In some examples, for each image frame, an updated state is stored and provided as a prior state (S[t]) for the next frame (S[t+1]). The next frame will be S[t+1] and uses S[t] prior state information. A temporal unit, such as the temporal unit 220 of FIG. 2, maintains the recurrent state S[t] using the prior state S[t−1].

At 620, for a selected frame of the sequence of image frames, a segmentation map is generated. The segmentation map assigns pixels to semantic classes based in part on feedback from at least one previous frame of the sequence of image frames. In some examples, the feedback used at 620 includes a respective segmentation map for the at least one previous image frame, thereby stabilizing semantic labeling across time and enabling the segmentation map for the selected frame to reflect temporally informed class assignments. In some examples, the segmentation map provides, for each pixel, a confidence associated with a corresponding assigned semantic class.

At 630, spatial relationships between the semantic classes in the segmentation map are determined. Determining spatial relationships may include evaluating adjacency, overlap, containment, or other relative spatial arrangements of regions corresponding to the semantic classes.

At 635, semantic coherence between the semantic classes in the segmentation map is determined. In some examples, determining semantic coherence includes determining a coherence score based on confidences associated with the semantic classes in the segmentation map and a spatial arrangement of regions corresponding to the semantic classes.

In some examples, determining semantic coherence includes determining one or more combinations of semantic classes in the segmentation map and determining that spatial relationships between the semantic classes are semantically consistent with an object hypothesis. In various examples, 630 and 635 include complementary analyses over the semantic classes present in the segmentation map.

At 640, at least one object in the selected frame is identified based on the spatial relationships and the semantic coherence determined at 630 and 635. In some examples, identifying the at least one object comprises defining an object region as a union of regions corresponding to a plurality of specified semantic classes in the selected segmentation map, such as, in a face-detection example, facial skin and facial hair. In some examples, determining the spatial relationships includes applying deterministic, rule-based composition using at least one of an adjacency threshold and a coverage threshold between regions corresponding to the semantic classes. In some examples, determining the spatial relationships includes applying pre-defined logic and/or pre-defined rules using at least one of an adjacency threshold and a coverage threshold between regions corresponding to the semantic classes. In some examples, the identification at 640 is performed by a reasoning layer that receives as input outputs of the spatial relationship determination and the semantic coherence determination.

At 650, an object detection output is generated, defining the at least one object identified at 640. The object detection output can include a corresponding confidence score based on the semantic coherence. In some examples, the corresponding confidence score is derived from the semantic coherence between the semantic classes rather than from local visual similarity.

At 660, the object detection is output for downstream use. In various examples, downstream use can include enabling robust object tracking and related camera or vision functions even in scenarios where conventional landmark-based detectors fail due to missing or occluded visual features.

### Example DNN for Object Detection

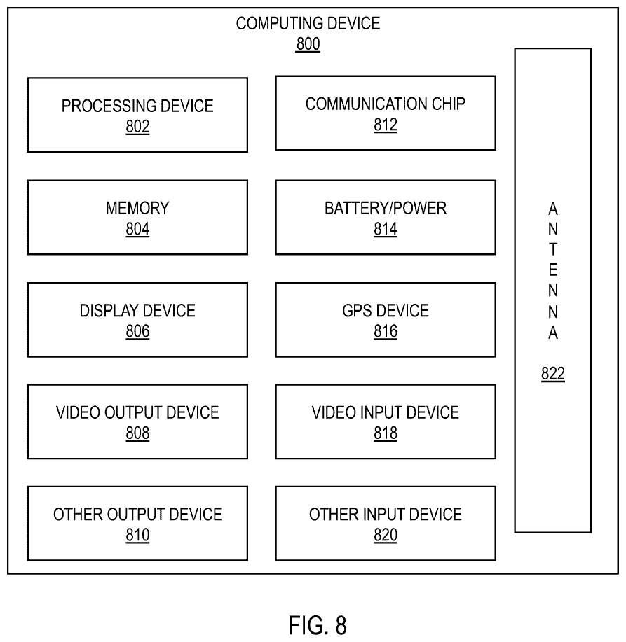

FIG. 7 is a block diagram of an example DNN system 700, in accordance with various embodiments. The DNN system 700 trains DNNs for various tasks, including object detection for video frames. The DNN system 700 includes an interface module 710, an object detection model 720, a training module 730, a validation module 740, an inference module 750, and a datastore 760. In other embodiments, alternative configurations, different or additional components may be included in the DNN system 700. Further, functionality attributed to a component of the DNN system 700 may be accomplished by a different component included in the DNN system 700 or a different system. The DNN system 700 or a component of the DNN system 700 (e.g., the training module 730 or inference module 750) may include the computing device 800 in FIG. 8.

The interface module 710 facilitates communication of the DNN system 700 with other systems. As an example, the interface module 710 supports the DNN system 700 to distribute trained DNNs to other systems, e.g., computing devices configured to apply DNNs to perform tasks. As another example, the interface module 710 establishes communication between the DNN system 700 and an external database to receive data that can be used to train DNNs or input into DNNs to perform tasks. In some embodiments, data received by the interface module 710 may have a data structure, such as a matrix. In some embodiments, data received by the interface module 710 may be an image, a series of images, and/or a video stream.

The object detection model 720 identifies objects in images. In some examples, the object detection model 720 performs object detection on image sequences (e.g., videos). In general, the object detection model 720 includes a spatiotemporal scene understanding module and a scene structure analysis module. The object detection model 720 receives the input image and feedback from a previous image, generates a segmentation map, uses the segmentation map to generate object hypotheses, and identifies one or more objects in the current image. During training, the object detection model 720 can use ground-truth object detection maps.

The training module 730 trains DNNs by using training datasets. In some embodiments, a training dataset for training a DNN may include one or more images and/or videos, each of which may be a training sample. In some examples, the training module 730 trains the object detection model 720. The training module 730 may receive real-world image data for processing with the object detection model 720. In some embodiments, the training module 730 may input different data into different layers of the DNN. For every subsequent DNN layer, the input data may be less than the previous DNN layer. In some examples, the object detection model 720 can be trained with ground-truth maps of images having a plurality of selected objects. In some examples, the difference between the object detection model 720's object detection output and the corresponding ground-truth object detection can be measured based on whether each object was detected (e.g., the number of objects detected), and in some examples, the difference can be measured based on the number of pixels in the corresponding outputs that have different classifications from each other.

In some embodiments, a part of the training dataset may be used to initially train the DNN, and the rest of the training dataset may be held back as a validation subset used by the validation module 740 to validate the performance of a trained DNN. The portion of the training dataset not including the tuning subset and the validation subset may be used to train the DNN.

The training module 730 also determines hyperparameters for training the DNN. Hyperparameters are variables specifying the DNN training process. Hyperparameters are different from parameters inside the DNN (e.g., weights of filters). In some embodiments, hyperparameters include variables determining the architecture of the DNN, such as the number of hidden layers, etc. Hyperparameters also include variables that determine how the DNN is trained, such as batch size, number of epochs, etc. A batch size defines the number of training samples to work through before updating the parameters of the DNN. The batch size is the same as or smaller than the number of samples in the training dataset. The training dataset can be divided into one or more batches. The number of epochs defines how many times the entire training dataset is passed forward and backward through the entire network. The number of epochs defines the number of times that the deep learning algorithm works through the entire training dataset. One epoch means that each training sample in the training dataset has had an opportunity to update the parameters inside the DNN. An epoch may include one or more batches. The number of epochs may be 1, 10, 50, 100, or even larger.

The training module 730 defines the architecture of the DNN, e.g., based on some of the hyperparameters. The architecture of the DNN includes an input layer, an output layer, and a plurality of hidden layers. The input layer of a DNN may include tensors (e.g., a multidimensional array) specifying attributes of the input image, such as the height of the input image, the width of the input image, and the depth of the input image (e.g., the number of bits specifying the color of a pixel in the input image). The output layer includes labels of objects in the input image. The hidden layers are layers between the input layer and output layer. The hidden layers include one or more convolutional layers and one or more other types of layers, such as pooling layers, fully connected layers, normalization layers, softmax or logistic layers, and so on. The convolutional layers of the DNN abstract the input image to a feature map that is represented by a tensor specifying the feature map height, the feature map width, and the feature map channels (e.g., red, green, blue images include three channels). A pooling layer is used to reduce the spatial volume of the input image after convolution. It is used between two convolutional layers. A fully connected layer involves weights, biases, and neurons. It connects neurons in one layer to neurons in another layer. It is used to classify images between different categories by training.

In the process of defining the architecture of the DNN, the training module 730 also adds an activation function to a hidden layer or the output layer. An activation function of a layer transforms the weighted sum of the input of the layer to an output of the layer. The activation function may be, for example, a rectified linear unit activation function, a tangent activation function, or other types of activation functions.

After the training module 730 defines the architecture of the DNN, the training module 730 inputs a training dataset into the DNN. The training dataset includes a plurality of training samples. An example of a training dataset includes a series of images of a video stream. Unlabeled, real-world video is input to the object detection model, and processed using the object detection model parameters of the DNN to produce model-generated output.

The training module 730 may train the DNN for a predetermined number of epochs. The number of epochs is a hyperparameter that defines the number of times that the deep learning algorithm will work through the entire training dataset. One epoch means that each sample in the training dataset has had an opportunity to update internal parameters of the DNN. After the training module 730 finishes the predetermined number of epochs, the training module 730 may stop updating the parameters in the DNN. The DNN having the updated parameters is referred to as a trained DNN.

The validation module 740 verifies the accuracy of trained DNNs. In some embodiments, the validation module 740 inputs samples in a validation dataset into a trained DNN and uses the outputs of the DNN to determine the model accuracy. In some embodiments, a validation dataset may be formed of some or all the samples in the training dataset. Additionally or alternatively, the validation dataset includes additional samples, other than those in the training sets. In some embodiments, the validation module 740 may determine an accuracy score measuring the precision, recall, or a combination of precision and recall of the DNN. The validation module 740 may use the following metrics to determine the accuracy score: Precision=TP/(TP+FP) and Recall=TP/(TP+FN), where precision may be how many the reference classification model correctly predicted (TP or true positives) out of the total it predicted (TP+FP or false positives), and recall may be how many the reference classification model correctly predicted (TP) out of the total number of objects that did have the property in question (TP+FN or false negatives). The F-score (F-score=2*PR/(P+R)) unifies precision and recall into a single measure.

The validation module 740 may compare the accuracy score with a threshold score. In an example where the validation module 740 determines that the accuracy score of the augmented model is lower than the threshold score, the validation module 740 instructs the training module 730 to re-train the DNN. In one embodiment, the training module 730 may iteratively re-train the DNN until the occurrence of a stopping condition, such as the accuracy measurement indicating that the DNN may be sufficiently accurate, or a number of training rounds having taken place.

The inference module 750 applies the trained or validated DNN to perform tasks. The inference module 750 may run inference processes of a trained or validated DNN. In some examples, inference makes use of the forward pass to produce model-generated output for unlabeled real-world data. For instance, the inference module 750 may input real-world data into the DNN and receive an output of the DNN. The output of the DNN may provide a solution to the task for which the DNN is trained.

The inference module 750 may aggregate the outputs of the DNN to generate a final result of the inference process. In some embodiments, the inference module 750 may distribute the DNN to other systems, e.g., computing devices in communication with the DNN system 700, for the other systems to apply the DNN to perform the tasks. The distribution of the DNN may be done through the interface module 710. In some embodiments, the DNN system 700 may be implemented in a server, such as a cloud server, an edge server, and so on. The computing devices may be connected to the DNN system 700 through a network. Examples of the computing devices include edge devices.

The datastore 760 stores data received, generated, used, or otherwise associated with the DNN system 700. For example, the datastore 760 stores video processed by the object detection model 720 or used by the training module 730, validation module 740, and the inference module 750. The datastore 760 may also store other data generated by the training module 730 and validation module 740, such as the hyperparameters for training DNNs, internal parameters of trained DNNs (e.g., values of tunable parameters of activation functions, such as Fractional Adaptive Linear Units (FALUs)), etc. In the embodiment of FIG. 7, the datastore 760 is a component of the DNN system 700. In other embodiments, the datastore 760 may be external to the DNN system 700 and communicate with the DNN system 700 through a network.

For object detection model training, the input can include an input image frame and a labeled ground-truth object detection model-processed image. In various examples, the input image frame is received at an object detection module such as the object detection model of the object detection system 100 or the object detection model 720. In other examples, the input image frame can be received at the training module 730 or the inference module 750 of FIG. 7. The imager can be a camera, such as a video camera. The input image frame can be a still image from the video camera feed. The input image frame can include a matrix of pixels, each pixel having a color, lightness, and/or other parameter. Various steps can be repeated to further adjust the object detection model parameters. In some examples, the training can be repeated with a new input image frame and ground-truth object detection model-processed image.

### Example Computing Device

FIG. 8 is a block diagram of an example computing device 800, in accordance with various embodiments. In some embodiments, the computing device 800 may be used for at least part of the deep learning system 700 in FIG. 7. A number of components are illustrated in FIG. 8 as included in the computing device 800, but any one or more of these components may be omitted or duplicated, as suitable for the application. In some embodiments, some or all of the components included in the computing device 800 may be attached to one or more motherboards. In some embodiments, some or all of these components are fabricated onto a single system on a chip (SoC) die. Additionally, in various embodiments, the computing device 800 may not include one or more of the components illustrated in FIG. 8, but the computing device 800 may include interface circuitry for coupling to the one or more components. For example, the computing device 800 may not include a display device 806, but may include display device interface circuitry (e.g., a connector and driver circuitry) to which a display device 806 may be coupled. In another set of examples, the computing device 800 may not include a video input device 818 or a video output device 808, but may include video input or output device interface circuitry (e.g., connectors and supporting circuitry) to which a video input device 818 or video output device 808 may be coupled.

The computing device 800 may include a processing device 802 (e.g., one or more processing devices). The processing device 802 processes electronic data from registers and/or memory to transform that electronic data into other electronic data that may be stored in registers and/or memory. The computing device 800 may include a memory 804, which may itself include one or more memory devices such as volatile memory (e.g., DRAM), nonvolatile memory (e.g., read-only memory (ROM)), high-bandwidth memory (HBM), flash memory, solid-state memory, and/or a hard drive. In some embodiments, the memory 804 may include memory that shares a die with the processing device 802. In some embodiments, the memory 804 includes one or more non-transitory computer-readable media storing instructions executable for object detection, e.g., the method 600 described above in conjunction with FIG. 6 or some operations performed by the DNN system 700 in FIG. 7. The instructions stored in the one or more non-transitory computer-readable media may be executed by the processing device 802.

In some embodiments, the computing device 800 may include a communication chip 812 (e.g., one or more communication chips). For example, the communication chip 812 may be configured for managing wireless communications for the transfer of data to and from the computing device 800. The term “wireless” and its derivatives may be used to describe circuits, devices, systems, methods, techniques, communications channels, etc., that may communicate data using modulated electromagnetic radiation through a non-solid medium. The term does not imply that the associated devices do not contain any wires, although in some embodiments they might not.

The communication chip 812 may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long-Term Evolution (LTE) project along with any amendments, updates, and/or revisions (e.g., advanced LTE project, ultra-mobile broadband (UMB) project (also referred to as “3GPP2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. The communication chip 812 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication chip 812 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chip 812 may operate in accordance with code-division multiple access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication chip 812 may operate in accordance with other wireless protocols in other embodiments. The computing device 800 may include an antenna 822 to facilitate wireless communications and/or to receive other wireless communications (such as AM or FM radio transmissions).

In some embodiments, the communication chip 812 may manage wired communications, such as electrical, optical, or any other suitable communication protocols (e.g., the Ethernet). As noted above, the communication chip 812 may include multiple communication chips. For instance, a first communication chip 812 may be dedicated to shorter-range wireless communications such as Wi-Fi or Bluetooth, and a second communication chip 812 may be dedicated to longer-range wireless communications such as global positioning system (GPS), EDGE, GPRS, CDMA, WiMAX, LTE, EV-DO, or others. In some embodiments, a first communication chip 812 may be dedicated to wireless communications, and a second communication chip 812 may be dedicated to wired communications.

The computing device 800 may include battery/power circuitry 814. The battery/power circuitry 814 may include one or more energy storage devices (e.g., batteries or capacitors) and/or circuitry for coupling components of the computing device 800 to an energy source separate from the computing device 800 (e.g., AC line power).

The computing device 800 may include a display device 806 (or corresponding interface circuitry, as discussed above). The display device 806 may include any visual indicators, such as a heads-up display, a computer monitor, a projector, a touchscreen display, a liquid crystal display (LCD), a light-emitting diode display, or a flat panel display, for example.

The computing device 800 may include a video output device 808 (or corresponding interface circuitry, as discussed above). The video output device 808 may include any device that generates an audible indicator, such as speakers, headsets, or earbuds, for example.

The computing device 800 may include a video input device 818 (or corresponding interface circuitry, as discussed above). The video input device 818 may include any device that generates a signal representative of a sound, such as microphones, microphone arrays, or digital instruments (e.g., instruments having a musical instrument digital interface (MIDI) output).

The computing device 800 may include a GPS device 816 (or corresponding interface circuitry, as discussed above). The GPS device 816 may be in communication with a satellite-based system and may receive a location of the computing device 800, as known in the art.

The computing device 800 may include another output device 810 (or corresponding interface circuitry, as discussed above). Examples of the other output device 810 may include a video codec, a printer, a wired or wireless transmitter for providing information to other devices, or an additional storage device.

The computing device 800 may include another input device 820 (or corresponding interface circuitry, as discussed above). Examples of the other input device 820 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing device 800 may have any desired form factor, such as a handheld or mobile computer system (e.g., a cell phone, a smartphone, a mobile internet device, a music player, a tablet computer, a laptop computer, a netbook computer, an ultrabook computer, a personal digital assistant (PDA), an ultramobile personal computer, etc.), a desktop computer system, a server or other networked computing component, a printer, a scanner, a monitor, a set-top box, an entertainment control unit, a vehicle control unit, a digital camera, a digital video recorder, or a wearable computer system. In some embodiments, the computing device 800 may be any other electronic device that processes data.

### Selected Examples

The following paragraphs provide various examples of the embodiments disclosed herein.

Example 1 provides an apparatus, including a computer processor for executing computer program instructions; and a non-transitory computer-readable memory storing computer program instructions executable by the computer processor to perform operations including receiving a sequence of image frames; generating, for a selected frame of the sequence of image frames, a selected segmentation map assigning pixels to semantic classes based in part on feedback from at least one previous frame of the sequence of image frames; determining spatial relationships between the semantic classes in the selected segmentation map; determining semantic coherence between the semantic classes in the selected segmentation map; identifying at least one object in the selected frame based on the spatial relationships and the semantic coherence; generating an object detection output defining the at least one object and a corresponding confidence score based on the semantic coherence; and outputting the object detection output.

Example 2 provides the apparatus of example 1, where determining semantic coherence includes determining a coherence score.

Example 3 provides the apparatus of example 2, where the coherence score is determined based on confidences associated with the semantic classes in the selected segmentation map, and a spatial arrangement of regions corresponding to the semantic classes.

Example 4 provides the apparatus of any one of examples 1-3, where determining semantic coherence includes determining one or more combinations of semantic classes in the selected segmentation map, and determining that spatial relationships between the semantic classes are semantically consistent with an object hypothesis.

Example 5 provides the apparatus of any one of examples 1-4, where the corresponding confidence score of the object detection output is derived from the semantic coherence between the semantic classes rather than from local visual similarity.

Example 6 provides the apparatus of any one of examples 1-5, where the feedback is a respective segmentation map for the at least one previous image.

Example 7 provides the apparatus of any one of examples 1-6, where the selected segmentation map provides, for each pixel, a confidence associated with a corresponding assigned semantic class.

Example 8 provides the apparatus of any one of examples 1-7, where identifying the at least one object includes defining an object region as a union of regions corresponding to a plurality of specified semantic classes in the selected segmentation map.

Example 9 provides the apparatus of example 8, where the plurality of specified semantic classes include facial skin and facial hair.

Example 10 provides the apparatus of any one of examples 1-9, where determining the spatial relationships further includes applying deterministic, rule-based composition using at least one of an adjacency threshold and a coverage threshold between regions corresponding to the semantic classes.

Example 11 provides the apparatus of any one of examples 1-10, where identifying the at least one object is performed by a reasoning layer that receives as input outputs of the spatial relationship determination and the semantic coherence determination.

Example 12 provides the apparatus of example 11, where the reasoning layer includes a learnable model configured to infer object presence from combinations of semantic classes and the determined spatial relationships.

Example 13 provides the apparatus of any one of examples 1-12, further including, in a multi-object scenario, separating candidate regions corresponding to the at least one object using connected-components analysis on semantically consistent regions in the selected segmentation map.

Example 14 provides the apparatus of any one of examples 1-13, where identifying the at least one object is performed by a reasoning layer that receives as input outputs of the spatial relationship determination and the semantic coherence determination.

Example 15 provides the apparatus of example 14, where the reasoning layer includes a learnable model configured to infer object presence from combinations of semantic classes and the determined spatial relationships.

Example 16 provides the apparatus of example 15, where the learnable model includes a neural network.

Example 17 provides the apparatus of example 15, where the learnable model includes a support vector machine.

Example 18 provides the apparatus of any one of examples 1-17, where generating the selected segmentation map includes using a temporal decoding unit configured to incorporate feedback from the at least one previous frame to maintain semantic consistency across consecutive frames.

Example 19 provides the apparatus of example 18, where the temporal decoding unit includes a convolutional GRU-based unit configured to enable feedback at different resolutions from previous frames.

Example 20 provides the apparatus of any one of examples 1-19, where generating the object detection output includes generating at least one of a bounding region or a pixel-accurate mask corresponding to the at least one object.

Example 21 provides the apparatus of any one of examples 1-20, where the operations reuse outputs of an existing scene understanding algorithm to provide object detection with reduced latency and power relative to running a separate appearance-based object detector.

Example 22 provides the apparatus of example 21, where the reuse enables generating the object detection output without performing a dedicated landmark-based face detection stage in post-processing after capture.

Example 23 provides one or more non-transitory computer-readable media storing instructions executable to perform operations, the operations including receiving a sequence of image frames; generating, for a selected frame of the sequence of image frames, a selected segmentation map assigning pixels to semantic classes based in part on feedback from at least one previous frame of the sequence of image frames; determining spatial relationships between the semantic classes in the selected segmentation map; determining semantic coherence between the semantic classes in the selected segmentation map; identifying at least one object in the selected frame based on the spatial relationships and the semantic coherence; generating an object detection output defining the at least one object and a corresponding confidence score based on the semantic coherence; and outputting the object detection output.

Example 24 provides the one or more non-transitory computer-readable media of example 23, where determining semantic coherence includes determining a coherence score.

Example 25 provides the one or more non-transitory computer-readable media of example 24, where the coherence score is determined based on confidences associated with the semantic classes in the selected segmentation map, and a spatial arrangement of regions corresponding to the semantic classes.

Example 26 provides the one or more non-transitory computer-readable media of example 23, where determining semantic coherence includes determining one or more combinations of semantic classes in the selected segmentation map, and determining that spatial relationships between the semantic classes are semantically consistent with an object hypothesis.

Example 27 provides the one or more non-transitory computer-readable media of any one of examples 23-25, where the corresponding confidence score of the object detection output is derived from the semantic coherence between the semantic classes rather than from local visual similarity.

Example 28 provides the one or more non-transitory computer-readable media of any one of examples 23-27, where the feedback is a respective segmentation map for the at least one previous image.

Example 29 provides the one or more non-transitory computer-readable media of any one of examples 23-28, where the selected segmentation map provides, for each pixel, a confidence associated with a corresponding assigned semantic class.

Example 30 provides the one or more non-transitory computer-readable media of any one of examples 23-29, where identifying the at least one object includes defining an object region as a union of regions corresponding to a plurality of specified semantic classes in the selected segmentation map.

Example 31 provides the one or more non-transitory computer-readable media of example 30, where the plurality of specified semantic classes include facial skin and facial hair.

Example 32 provides the one or more non-transitory computer-readable media of any one of examples 23-31, where determining the spatial relationships further includes applying deterministic, rule-based composition using at least one of an adjacency threshold and a coverage threshold between regions corresponding to the semantic classes.

Example 33 provides the one or more non-transitory computer-readable media of any one of examples 23-32, where identifying the at least one object is performed by a reasoning layer that receives as input outputs of the spatial relationship determination and the semantic coherence determination.

Example 34 provides the one or more non-transitory computer-readable media of example 33, where the reasoning layer includes a learnable model configured to infer object presence from combinations of semantic classes and the determined spatial relationships.

Example 35 provides the one or more non-transitory computer-readable media of any one of examples 23-34, further including, in a multi-object scenario, separating candidate regions corresponding to the at least one object using connected-components analysis on semantically consistent regions in the selected segmentation map.

Example 36 provides the one or more non-transitory computer-readable media of example 34, where the learnable model includes a neural network.

Example 37 provides the one or more non-transitory computer-readable media of any one of examples 34-36, where the learnable model includes a support vector machine.

Example 38 provides the one or more non-transitory computer-readable media of any one of examples 23-37, where generating the selected segmentation map includes using a temporal decoding unit configured to incorporate feedback from the at least one previous frame to maintain semantic consistency across consecutive frames.

Example 39 provides the one or more non-transitory computer-readable media of example 38, where the temporal decoding unit includes a convolutional GRU-based unit configured to enable feedback at different resolutions from previous frames.

Example 40 provides the one or more non-transitory computer-readable media of any one of examples 23-39, where generating the object detection output includes generating at least one of a bounding region or a pixel-accurate mask corresponding to the at least one object.

Example 41 provides the one or more non-transitory computer-readable media of any one of examples 23-40, where the operations reuse outputs of an existing scene understanding algorithm to provide object detection with reduced latency and power relative to running a separate appearance-based object detector.

Example 42 provides the one or more non-transitory computer-readable media of example 41, where the reuse enables generating the object detection output without performing a dedicated landmark-based face detection stage in post-processing after capture.

Example 43 provides a computer-implemented method, including receiving a sequence of image frames; generating, for a selected frame of the sequence of image frames, a selected segmentation map assigning pixels to semantic classes based in part on feedback from at least one previous frame of the sequence of image frames; determining spatial relationships between the semantic classes in the selected segmentation map; determining semantic coherence between the semantic classes in the selected segmentation map; identifying at least one object in the selected frame based on the spatial relationships and the semantic coherence; generating an object detection output defining the at least one object and a corresponding confidence score based on the semantic coherence; and outputting the object detection output.

Example 44 provides the computer-implemented method of example 43, where determining semantic coherence includes determining a coherence score.

Example 45 provides the computer-implemented method of example 44, where the coherence score is determined based on confidences associated with the semantic classes in the selected segmentation map and a spatial arrangement of regions corresponding to the semantic classes.

Example 46 provides the computer-implemented method of any one of examples 43-45, where determining semantic coherence includes determining one or more combinations of semantic classes in the selected segmentation map, and determining that spatial relationships between the semantic classes are semantically consistent with an object hypothesis.

Example 47 provides the computer-implemented method of any one of examples 43-46, where the corresponding confidence score of the object detection output is derived from the semantic coherence between the semantic classes rather than from local visual similarity.

Example 48 provides the computer-implemented method of any one of examples 43-47, where the feedback is a respective segmentation map for the at least one previous image.

Example 49 provides the computer-implemented method of any one of examples 43-48, where the selected segmentation map provides, for each pixel, a confidence associated with a corresponding assigned semantic class.

Example 50 provides the computer-implemented method of any one of examples 43-49, where identifying the at least one object includes defining an object region as a union of regions corresponding to a plurality of specified semantic classes in the selected segmentation map.

Example 51 provides the computer-implemented method of example 50, where the plurality of specified semantic classes include facial skin and facial hair.

Example 52 provides the computer-implemented method of any one of examples 43-51, where determining the spatial relationships further includes applying deterministic, rule-based composition using at least one of an adjacency threshold and a coverage threshold between regions corresponding to the semantic classes.

Example 53 provides the computer-implemented method of any one of examples 43-52, where identifying the at least one object is performed by a reasoning layer that receives as input outputs of the spatial relationship determination and the semantic coherence determination.

Example 54 provides the computer-implemented method of example 53, where the reasoning layer includes a learnable model configured to infer object presence from combinations of semantic classes and the determined spatial relationships.

Example 55 provides the computer-implemented method of any one of examples 43-54, further including, in a multi-object scenario, separating candidate regions corresponding to the at least one object using connected-components analysis on semantically consistent regions in the selected segmentation map.

Example 56 provides the computer-implemented method of example 54, where the learnable model includes a neural network.

Example 57 provides the computer-implemented method of any one of examples 54-56, where the learnable model includes a support vector machine.

Example 58 provides the computer-implemented method of any one of examples 43-57, where generating the selected segmentation map includes using a temporal decoding unit configured to incorporate feedback from the at least one previous frame to maintain semantic consistency across consecutive frames.

Example 59 provides the computer-implemented method of example 58, where the temporal decoding unit includes a convolutional GRU-based unit configured to enable feedback at different resolutions from previous frames.

Example 60 provides the computer-implemented method of any one of examples 43-59, where generating the object detection output includes generating at least one of a bounding region or a pixel-accurate mask corresponding to the at least one object.

Example 61 provides the computer-implemented method of any one of examples 43-60, where the operations reuse outputs of an existing scene understanding algorithm to provide object detection with reduced latency and power relative to running a separate appearance-based object detector.

Example 62 provides the computer-implemented method of example 61, where the reuse enables generating the object detection output without performing a dedicated landmark-based face detection stage in post-processing after capture.

Example 63 provides the apparatus of any one of examples 1-3, where determining semantic coherence includes determining one or more combinations of semantic classes in the selected segmentation map, and determining that spatial relationships between the semantic classes are semantically consistent across consecutive frames.

Example 64 provides the apparatus of any one of examples 1-9, where determining the spatial relationships further includes applying predefined rules using at least one of an adjacency threshold and a coverage threshold between regions corresponding to the semantic classes.

Example 65 provides the apparatus of any one of examples 1-9, where determining the spatial relationships further includes applying predefined logic using at least one of an adjacency threshold and a coverage threshold between regions corresponding to the semantic classes.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

1. An apparatus, comprising:
a computer processor for executing computer program instructions; and
a non-transitory computer-readable memory storing computer program instructions executable by the computer processor to perform operations comprising:
receiving a sequence of image frames;
generating, for a selected frame of the sequence of image frames, a selected segmentation map assigning pixels to semantic classes based in part on feedback from at least one previous frame of the sequence of image frames;
determining spatial relationships between the semantic classes in the selected segmentation map;
determining semantic coherence between the semantic classes in the selected segmentation map;
identifying at least one object in the selected frame based on the spatial relationships and the semantic coherence;
generating an object detection output defining the at least one object and a corresponding confidence score based on the semantic coherence; and
outputting the object detection output.

2. The apparatus of claim 1, wherein determining semantic coherence includes determining a coherence score.

3. The apparatus of claim 2, wherein the coherence score is determined based on confidences associated with the semantic classes in the selected segmentation map, and a spatial arrangement of regions corresponding to the semantic classes.

4. The apparatus of claim 1, wherein determining semantic coherence comprises determining one or more combinations of semantic classes in the selected segmentation map, and determining that spatial relationships between the semantic classes are semantically consistent across consecutive frames.

5. The apparatus of claim 1, wherein the corresponding confidence score of the object detection output is derived from the semantic coherence between the semantic classes.

6. The apparatus of claim 1, wherein the feedback is a respective segmentation map for the at least one previous frame.

7. The apparatus of claim 1, wherein the selected segmentation map provides, for each pixel, a confidence associated with a corresponding assigned semantic class.

8. The apparatus of claim 1, wherein identifying the at least one object comprises defining an object region as a union of regions corresponding to a plurality of specified semantic classes in the selected segmentation map.

9. The apparatus of claim 1, wherein determining the spatial relationships further comprises applying pre-defined rules using at least one of an adjacency threshold and a coverage threshold between regions corresponding to the semantic classes.

10. The apparatus of claim 1, wherein identifying the at least one object is performed by a reasoning layer that receives as input outputs of the spatial relationship determination and the semantic coherence determination.

11. The apparatus of claim 10, wherein the reasoning layer comprises a learnable model configured to infer object presence from combinations of the semantic classes and the spatial relationships.

12. One or more non-transitory computer-readable media storing instructions executable to perform operations, the operations comprising:
receiving a sequence of image frames;
generating, for a selected frame of the sequence of image frames, a selected segmentation map assigning pixels to semantic classes based in part on feedback from at least one previous frame of the sequence of image frames;
determining spatial relationships between the semantic classes in the selected segmentation map;
determining semantic coherence between the semantic classes in the selected segmentation map;
identifying at least one object in the selected frame based on the spatial relationships and the semantic coherence;
generating an object detection output defining the at least one object and a corresponding confidence score based on the semantic coherence; and
outputting the object detection output.

13. The one or more non-transitory computer-readable media of claim 12, wherein determining semantic coherence includes determining a coherence score.

14. The one or more non-transitory computer-readable media of claim 13, wherein the coherence score is determined based on confidences associated with the semantic classes in the selected segmentation map, and a spatial arrangement of regions corresponding to the semantic classes.

15. The one or more non-transitory computer-readable media of claim 12, wherein determining semantic coherence comprises determining one or more combinations of semantic classes in the selected segmentation map, and determining that spatial relationships between the semantic classes are semantically consistent with across consecutive frames.

16. The one or more non-transitory computer-readable media of claim 12, wherein the corresponding confidence score of the object detection output is derived from the semantic coherence between the semantic classes.

17. The one or more non-transitory computer-readable media of claim 12, wherein the feedback is a respective segmentation map for the at least one previous image.

18. The one or more non-transitory computer-readable media of claim 12, wherein the selected segmentation map provides, for each pixel, a confidence associated with a corresponding assigned semantic class.

19. The one or more non-transitory computer-readable media of claim 12, wherein identifying the at least one object comprises defining an object region as a union of regions corresponding to a plurality of specified semantic classes in the selected segmentation map.

20. A computer-implemented method, comprising:
receiving a sequence of image frames;
generating, for a selected frame of the sequence of image frames, a selected segmentation map assigning pixels to semantic classes based in part on feedback from at least one previous frame of the sequence of image frames;
determining spatial relationships between the semantic classes in the selected segmentation map;
determining semantic coherence between the semantic classes in the selected segmentation map;
identifying at least one object in the selected frame based on the spatial relationships and the semantic coherence;
generating an object detection output defining the at least one object and a corresponding confidence score based on the semantic coherence; and
outputting the object detection output.
